(19) United States
(12) Patent Application Publication
(10) Pub. No.: US 2023/0286327 A1
(43) Pub. Date: Sep. 14, 2023

(54) PNEUMATIC TIRE

(71) Applicant: Toyo Tire Corporation, Itami-shi (JP)

(72) Inventor: Tsuyoshi Fujioka, Itami-shi (JP)

(73) Assignee: Toyo Tire Corporation, Itami-shi (JP)

(21) Appl. No.: 18/102,262

(22) Filed: Jan. 27, 2023

(30) Foreign Application Priority Data
Mar. 10, 2022 (JP) 2022-037187

(51) Int. Cl. B60C 11/13; B60C 11/12

(52) U.S. Cl. CPC B60C 11/1353; B60C 11/12; B60C 2011/0348

(57) ABSTRACT

A pneumatic tire according to an embodiment includes a main groove extending in a tire circumferential direction on a tread, and a plurality of protrusions protruding from a bottom of the main groove and connected to walls on both sides in a tire axial direction of the main groove. Each of the protrusions is provided with a narrow groove extending in an extending direction of the main groove and dividing the protrusion into both sides in the tire axial direction, and the bottom of the narrow groove is at a higher position than the bottom of the main groove.

### CROSS-REFERENCE TO RELATED APPLICATIONS

This application claims the benefit of and priority to Japanese Patent Application No. 2022-037187 filed on Mar. 10, 2022, and the content thereof is incorporated herein by reference in its entirety.

### BACKGROUND OF THE INVENTION

### 1. Field of the Invention

The present invention relates to a pneumatic tire.

### 2. Description of Related Art

There is known a pneumatic tire provided with, inside main grooves, protrusions protruding from bottoms of the main grooves as described in JP2013-060191A. Since the main grooves are not easily deformed due to the existence of the protrusions, it is possible to prevent stones from being caught inside the main grooves because of deformation of the main grooves. However, drainability possessed by the main grooves may be reduced due to the existence of the protrusions inside the main grooves. In response to the above, as described in JP2013-060191A, there is proposed a pneumatic tire provided with grooves reaching the bottoms of the main grooves to completely divide each of protrusions into two at the protrusions inside the main grooves.

### SUMMARY OF THE INVENTION

However, when the grooves completely dividing each of protrusions into two are provided as described above, the main grooves may be largely deformed and stones are easily caught inside the main grooves even though the protrusions are provided inside the main grooves.

The invention has been made in view of the above circumstances, and an object of the present invention is to provide a pneumatic tire with good drainability, in which stones are not easily caught inside the main groove.

A pneumatic tire according to an embodiment includes a main groove extending in a tire circumferential direction on a tread, and a plurality of protrusions protruding from a bottom of the main groove and connected to walls on both sides in a tire axial direction of the main groove, in which each of the protrusions is provided with a narrow groove extending in an extending direction of the main groove and dividing the protrusion into both sides in the tire axial direction, and a bottom of the narrow groove is at a higher position than the bottom of the main groove.

The pneumatic tire according to an embodiment has good drainability, in which stones are not easily caught inside the main groove.

### BRIEF DESCRIPTION OF THE DRAWINGS

FIG. 1 shows a tread pattern of a pneumatic tire;

FIG. 2 is a cross-sectional view taken along A-A of FIG. 1;

FIG. 3 is a perspective view showing an inside of a center main groove;

FIG. 4 is a perspective view showing the inside of the center main groove; and

FIG. 5 is a perspective view showing the inside of the center main groove.

### DESCRIPTION OF EMBODIMENTS

An embodiment will be explained with reference to the drawings. The embodiment explained below is merely an example, and appropriate modifications within a scope not departing from the gist of the present invention are included in the scope of the present invention.

A pneumatic tire according to the embodiment has a general cross-sectional structure as the pneumatic tire except a tread. Specifically, beads (a bead corresponds to a portion including a bead core and a bead filler) are provided on both sides in a tire axial direction, and a carcass ply is provided from one bead toward the other bead in the tire axial direction. A belt is provided on an outer diameter side of the carcass ply, and the tread is provided on the outer diameter side of the belt. Moreover, an inner liner is provided inside the carcass ply, and sidewall rubbers are provided on both sides in the tire axial direction of the carcass ply. A plurality of rubber members are also provided in addition to the above to thereby form the pneumatic tire.

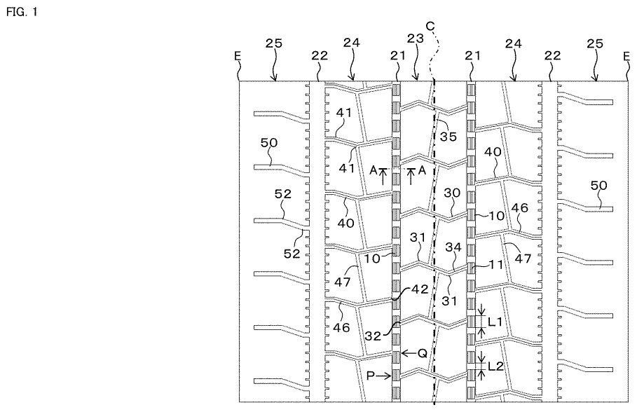

As shown in FIG. 1, two center main grooves 21 close to a tire equator C and two shoulder main grooves 22 close to tire ground contact ends E are provided on the tread as main grooves with a large width extending in a tire circumferential direction. These main grooves 21, 22 extend in a straight shape in the tire circumferential direction without bending. These main grooves 21, 22 have the same depth which is the deepest in grooves provided on the tread. The center main grooves 21 are narrower in width than the shoulder main grooves 22.

The main grooves in the embodiment correspond to the widest grooves on the tread and grooves having a width equal to or wider than the half of the width of the widest grooves in the grooves extending in the tire circumferential direction. Therefore, the width of the center main grooves 21 is equal to or wider than the half of the width of the shoulder main grooves 22.

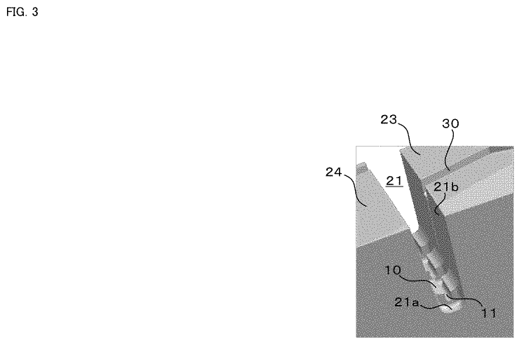

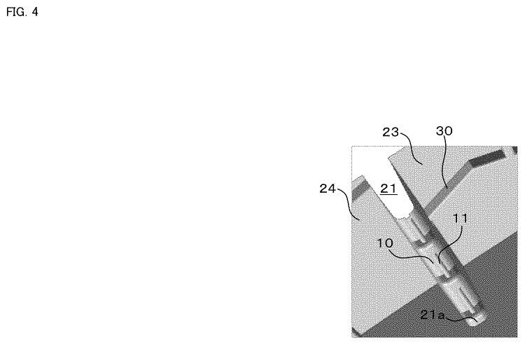

As can be seen from FIG. 1 to FIG. 5, a plurality of protrusions 10 protruding from bottoms 21a are provided in the two center main grooves 21, respectively. The protrusions 10 are connected to walls 21b on both sides in the tire axial direction of the center main groove 21. The plural protrusions 10 are arranged in one center main groove 21 at equal intervals.

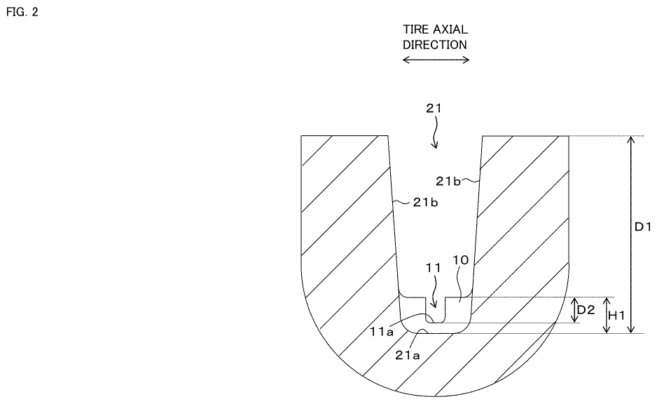

A height H1 (see FIG. 2) of the protrusion 10 is preferably 10% or more and 30% or less of a depth D1 (see FIG. 2) of the center main groove 21, and more preferably 10% or more and 20% or less thereof. The height H1 of the protrusion 10 is a height from the bottom 21a of the center main groove 21 to an opening end of a later-described narrow groove 11 with respect to a tire radial direction.

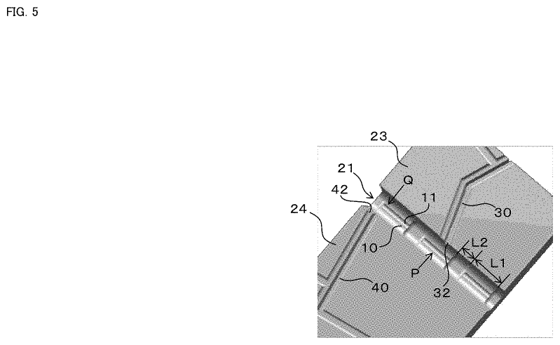

A length L1 (see FIG. 1, FIG. 5) in the tire circumferential direction of each protrusion 10 is preferably 0.8 times or more and 2.0 times or less of the width of the center main groove 21, and more preferably 0.97 times or more and 1.29 times or less thereof. The width of the center main groove 21 is a width measured at an opening end of the center main groove 21 with respect to a ground contact surface on the tread before being worn. The ratio (L2:L1) of the length L1 in the tire circumferential direction of the protrusion 10 and an interval L2 (see FIG. 1 and FIG. 5) between the protrusions 10 is preferably 1.0:1.0 to 1.0:2.5, and more preferably 1.0:1.5 to 1.0:2.1.

Each of the protrusions 10 is provided with the narrow groove 11 which divides the protrusion 10 into both sides in the tire axial direction. The narrow groove 11 extends in a straight line from one end to the other end of the protrusion 10 in an extending direction of the center main groove 21. As shown in FIG. 2, a bottom 11a of the narrow groove 11 is at a higher position than the bottom 21a of the center main groove 21. Accordingly, the protrusion 10 continues under the narrow groove 11. A depth D2 (see FIG. 2) of the narrow groove 11 is preferably 50% or more and 80% or less of the height H1 of the protrusion 10. A width of the narrow groove 11 is preferably 5% or more and 40% or less of the width of the center main groove 21, and more preferably 15% or more and 20% or less thereof. Note that the width of the narrow groove 11 is a width measured at the opening end of the narrow groove 11 with respect to the tire radial direction.

These protrusions 10 are provided only in the two center main grooves 21 of the main grooves 21, 22. The narrow grooves 11 are provided at all protrusions 10 in the two center main grooves 21.

As shown in FIG. 1, five lands are formed on the tread by the above main grooves 21, 22. Five lands include a center land 23 positioned on the tire equator C, quarter lands 24 on both sides of the center land 23, and shoulder lands 25 on the tire ground contact ends E side positioned on both sides in the tire axial direction.

These lands 23, 24, and 25 are each provided with axial direction grooves each having one or more bending points and extending in the tire axial direction. The axial direction grooves are grooves narrower in width than the main grooves 21, 22.

First, a plurality of center axial direction grooves 30 are provided on the center land 23 at intervals in the tire circumferential direction. The center axial direction grooves 30 open to the center main grooves 21 on both sides of the center land 23. A depth of the center axial direction grooves 30 is 10% or more and 30% or less of the depth D1 of the main grooves 21, 22. Each center axial direction groove 30 has two bending points 31.

On bottoms of the center axial direction grooves 30, center sipes 34 narrower in width than the center axial direction grooves 30 are provided. The center sipes 34 also open to the center main grooves 21 on both sides of the center land 23. The center sipes 34 also bend at the same positions as the center axial direction grooves 30. Bottoms of the center sipes 34 are at a higher position (position close to the ground contact surface) than the protrusions 10 in the center main grooves 21.

The axial direction grooves are grooves which are larger in width than 1.5 mm. The sipes are grooves having a width equal to or narrower than 1.5 mm.

Moreover, a plurality of quarter axial direction grooves 40 are provided on the quarter land 24 at intervals in the tire circumferential direction. The quarter axial direction grooves 40 open to the center main groove 21 and the shoulder main groove 22. A depth of the quarter axial direction grooves 40 is 10% or more and 30% or less of the depth D1 of the main grooves 21, 22. Each quarter axial direction groove 40 has two bending points 41.

On bottoms of the quarter axial direction grooves 40, quarter sipes 46 narrower in width than the quarter axial direction grooves 40 are provided. The quarter sipes 46 also open to the center main groove 21 and the shoulder main groove 22. The quarter sipes 46 also bend at the same positions as the quarter axial direction grooves 40. Bottoms of the quarter sipes 46 are at a higher position (position close to the ground contact surface) than the protrusions 10 in the center main grooves 21.

Moreover, a plurality of shoulder axial direction grooves 50 are provided on the shoulder land 25 at intervals in the tire circumferential direction. One end of each of the shoulder axial direction grooves 50 opens to the shoulder main groove 22. The other end of each of the shoulder axial direction grooves 50 is blocked inside the shoulder land 25 and placed at a position closer to the tire equator C than the tire ground contact end E. A depth of the shoulder axial direction grooves 50 is 10% or more and 30% or less of the depth D1 of the main grooves 21, 22. Each shoulder axial direction groove 50 has two bending points 52. No sipes are provided on bottoms of the shoulder axial direction grooves 50.

These axial direction grooves 30, 40, and 50 are arranged so as to be shifted from axial direction grooves on adjacent lands in the tire circumferential direction. Specifically, the center axial direction grooves 30 and the quarter axial direction grooves 40 are arranged so as to be shifted from one another in the tire circumferential direction, and do not overlap each other in the tire axial direction. The quarter axial direction grooves 40 on the quarter land 24 and the shoulder axial direction grooves 50 on the adjacent shoulder land 25 are arranged so as to be shifted from one another in the tire circumferential direction, and do not overlap each other in the tire axial direction. On the other hand, the axial direction grooves on lands not adjacent to each other may have overlapping areas in the tire axial direction.

The above-described protrusions 10 in the center main grooves 21 are provided adjacent to opening ends 32 (see FIG. 1 and FIG. 5) of the center axial direction grooves 30 with respect to the center main groove 21. The protrusions 10 are provided also adjacent to opening ends 42 (see FIG. 1 and FIG. 5) of the quarter axial direction grooves 40 with respect to the center main groove 21. As shown in FIG. 1, in planar view (that is, when seen from a direction perpendicular to the ground contact surface), the protrusions 10 look as if the protrusions 10 block the opening ends 32, 42 of the axial direction grooves 30, 40 with respect to the center main groove 21 (however; the protrusions 10 do not actually block the opening ends 32, 42 because the bottoms of the axial direction grooves 30, 40 are at higher positions than the protrusions 10).

The protrusions 10 are provided at all the opening ends 32, 42 of the center axial direction grooves 30 and the quarter axial direction grooves 40 with respect to the center main grooves 21. However, the protrusions 10 adjacent to the opening ends 32 of the center axial direction grooves 30 differ from the protrusions 10 adjacent to the opening ends 42 of the quarter axial direction grooves 40.

It is preferable that each of the protrusions 10 is arranged on the side of each of entire opening ends 32, 42 (places in the tire axial direction) as denoted by an arrow P in FIG. 1 and FIG. 5. In this preferable arrangement, the protrusions 10 look as if the protrusions 10 completely block the opening ends 32, 42 in planar view. However, as denoted by an arrow Q in FIG. 1 and FIG. 5, the protrusions 10 may be arranged to be slightly shifted with respect to the opening ends 32, 42 in the tire circumferential direction (namely, the protrusion 10 may be arranged on the side of only one part of each opening end). Both the arrangement denoted by the arrow P and the arrangement denoted by the arrow Q can be said to be the arrangement of the protrusions 10 which are provided adjacent to the opening ends 32, 42.

At least part of the protrusions 10 in the whole tread are preferably arranged in the manner denoted by the arrow P. Moreover, there exist protrusions 10 which are not adjacent to any of the opening ends 32, 42 of the axial direction grooves 30, 40 as shown in FIG. 1 and FIG. 5.

Furthermore, narrow grooves extending to be slightly inclined with respect to the tire circumferential direction are provided on the center land 23 and the quarter lands 24. The narrow grooves are grooves narrower in width than the main grooves 21, 22.

First, center narrow grooves 35 extending in a direction inclined with respect to the tire circumferential direction are provided on the center land 23. The center narrow groove 35 connects two center axial direction grooves 30 adjacent to each other in the tire circumferential direction. The center narrow groove 35 does not open to the center main groove 21 but opens to the center axial direction grooves 30. A depth of the center narrow grooves 35 is 10% or more and 30% or less of the depth D1 of the main grooves 21, 22. The center narrow grooves 35 and the center axial direction grooves 30 may have the same depth or different depths.

Then, quarter narrow grooves 47 extending in a direction inclined with respect to the tire circumferential direction are provided respectively on the two quarter lands 24. The quarter narrow groove 47 connects two quarter axial direction grooves 40 adjacent to each other in the tire circumferential direction. The quarter narrow groove 47 does not open to the main grooves 21, 22 but opens to the quarter axial direction grooves 40. A depth of the quarter narrow grooves 47 is 10% or more and 30% or less of the depth D1 of the main grooves 21, 22. The quarter narrow grooves 47 and the quarter axial direction grooves 40 may have the same depth or different depths.

The quarter narrow grooves 47 are inclined in a direction opposite to the center narrow grooves 35 with respect to the tire circumferential direction. Accordingly, an extended line of the quarter narrow groove 47 and an extended line of the center narrow groove 35 cross each other. Additionally, the quarter narrow grooves 47 on one quarter land 24 in the tire axial direction and the quarter narrow grooves 47 on the other quarter land 24 in the tire axial direction are parallel to each other. No narrow grooves extending in the tire circumferential direction are provided on the shoulder lands 25.

The pneumatic tire having the above characteristics is mounted to, for example, the front side of a vehicle.

As described above, the pneumatic tire according to the embodiment is provided with a plurality of protrusions 10 protruding from the bottom 21a and connected to walls 21b on both sides in the tire axial direction inside the center main groove 21. Due to the existence of the protrusions 10, stones do not easily enter the center main grooves 21. Also due to the existence of protrusions 10, the center main grooves 21 are not easily deformed into a shape in which stones easily enter the grooves and are not easily deformed into a shape in which stones caught therein are not discharged. As the center main grooves 21 are not easily deformed as described above, stones are not easily caught inside the center main grooves 21. Moreover, stones are not able to reach the bottom 21a of the center main groove 21 due to the existence of the protrusions 10; therefore, the belt under the tread is not damaged.

The narrow grooves 11 extending in the extending direction of the center main groove 21 and dividing the protrusions 10 into both sides in the tire axial direction are provided at the protrusions 10 inside the center main groove 21. Accordingly, water can pass along the narrow grooves 11 to thereby secure drainability obtained by the center main grooves 21. Even when the tread is worn and the protrusions 10 appear on the surface of the tire, drainability obtained by the narrow grooves 11 is maintained. Additionally, when the tread is worn and the protrusions 10 can be seen from the outside, people hardly feel that grooves disappear due to the existence of the narrow grooves 11, which prevents the tire from being replaced too early.

Then, the bottom 11a of the narrow groove 11 is at the higher position than the bottom 21a of the center main groove 21; therefore, the protrusion 10 is not divided into both sides in the tire axial direction and the protrusion 10 continues under the narrow groove 11. Therefore, a force of suppressing deformation of the center main grooves 21 due to the protrusions 10 works even though the narrow grooves 11 exist. As a result, stones are not easily caught in the center main grooves 21 and drainability due to the center main grooves 21 is also secured. Additionally, the protrusions 10 continue under the narrow grooves 11 and the protrusions 10 have high rigidity; therefore, the protrusions 10 are not easily damaged even when stones hit the protrusions 10.

Here, when the depth D2 of the narrow groove 11 is 50% or more of the height H1 of the protrusion 10, drainability due to the narrow groove 11 can be secured and people hardly feel that grooves disappear after wear proceeds to some degree. When the depth D2 of the narrow groove 11 is 80% or less of the height H1 of the protrusion 10, the effect of suppressing deformation of the center main groove 21 due to the protrusions 10 is sufficiently exhibited.

When the length L1 in the tire circumferential direction of the protrusion 10 is 0.8 times or more of the width of the center main groove 21, the rigidity of the protrusions 10 can be sufficiently secured, and the protrusions 10 are not easily damaged when stones hit the protrusions 10. When the length L1 in the tire circumferential direction of the protrusion 10 is 2.0 times or less of the width of the center main groove 21, drainability of the center main groove 21 can be sufficiently secured. When the length L1 in the tire circumferential direction of the protrusion 10 is 0.97 times or more to 1.29 times or less of the width of the center main groove 21, the above effects are further sufficiently generated.

When the width of the narrow groove 11 of the protrusion 10 is 5% or more of the width of the center main groove 21, drainability of the center main groove 21 can be sufficiently secured. When the width of the narrow groove 11 of the protrusion 10 is 40% or less of the width of the center main groove 21, the effect of suppressing deformation of the center main groove 21 due to the protrusions 10 can be sufficiently secured. When the width of the narrow groove 11 is 15% or more and 20% or less of the width of the center main groove 21, the above effects are further sufficiently generated.

When the height H1 of the protrusion 10 is 10% or more of the depth D1 of the center main groove 21, the effect of suppressing entering of stones due to the protrusions 10 is sufficiently exhibited. When the height H1 of the protrusion 10 is 30% or less of the depth D1 of the center main groove 21, drainability of the center main groove 21 can be sufficiently secured. When the height H1 of the protrusion 10 is 10% or more and 20% or less of the depth D1 of the center main groove 21, the above effects are further generated.

Moreover, a ground contact pressure is generally higher at sections close to the center main grooves as compared with other sections; therefore, stones are easily caught in the center main grooves. However, the protrusions 10 are provided in the center main grooves 21 in the embodiment to thereby make stones not easily caught in the center main grooves 21.

In general, stones caught in the straight-shaped main groove do not easily come off as compared with the case of a zigzag-shaped main groove. However, the protrusions 10 are provided in the straight-shaped center main grooves 21 in the embodiment, as a result, stones do not easily enter the center main grooves 21. Accordingly, difficulty in coming-off of stones is unlikely to be a problem.

The rigidity tends to be reduced at the opening ends 32, 42 of the center axial direction grooves 30 and the quarter axial direction grooves 40 with respect to the center main grooves 21. However, the protrusions 10 of the center main grooves 21 are provided adjacent to the opening ends 32, 42; therefore, the reduction of rigidity at the opening ends 32, 42 is suppressed and the rigidity of the tread is made uniform in the tire circumferential direction.

Moreover, the protrusions 10 adjacent to the opening ends 32 of the center axial direction grooves 30 differ from the protrusions 10 adjacent to the opening ends 42 of the quarter axial direction grooves 40, and each one of the protrusions 10 is provided with respect to each one of the opening ends 32, 42 of the center axial direction grooves 30 and the quarter axial direction grooves 40. Accordingly, the reduction of rigidity at the opening ends 32, 42 can be suppressed effectively.

The pneumatic tire exerts traction characteristics due to the existence of the axial direction grooves 30, 40 and 50 extending in the tire axial direction on the center land 23, the quarter lands 24, and the shoulder lands 25. As these axial direction grooves 30, 40 and 50 respectively have bending points 31, 41, and 52 to have portions inclined with respect to the tire axial direction, the pneumatic tire also exerts skid resistance.

The center narrow grooves 35 extending in the tire circumferential direction are provided on the center land 23, and the quarter narrow grooves 47 extending in the tire circumferential direction are provided on the quarter lands 24; therefore, the skid resistance of the pneumatic tire is further improved.

A large force in a lateral direction is applied to tires on the front side of the vehicle when the vehicle turns. The pneumatic tire according to the embodiment has excellent skid resistance; therefore, the pneumatic tire is suitable for the front tire.

Various modifications may be made in the above embodiment. Any one of modification examples to be described below may be applied to the above embodiment as well as two or more examples may be combined and applied to the above embodiment.

For example, one of or both of the center main groove and the shoulder groove may be main grooves extending in zigzag in the tire circumferential direction. Then, protrusions similar to the above protrusions 10 may be provided in the zigzag-shaped main grooves.

It is also preferable that sipes are provided respectively instead of the center axial direction grooves 30, the quarter axial direction grooves 40, and the shoulder axial direction grooves 50. In the above case, the sipes also open to the main grooves 21, 22. The width of the sipes in that case is also 1.5 mm or less. It is not necessary to further provide other sipes on the bottoms of the sipes in that case.

The protrusions inside the main grooves may be provided in both of the center main grooves 21 and the shoulder main grooves 22. The protrusions inside the main grooves may be provided only in the shoulder main grooves 22. Respective dimensions of protrusions inside the shoulder main groove 22 and narrow grooves formed therein with respect to respective dimensions of the shoulder main groove 22 are the same as respective dimensions of the protrusions 10 and the narrow grooves 11 inside the center main groove 21 with respect to respective dimensions of the center main groove 21.

### REFERENCE SIGNS LIST

C: tire equator
E: tire ground contact end
10: protrusion
11: narrow groove
11a: bottom
21: center main groove
21a: bottom
21b: wall
22: shoulder main groove
23: center land
24: quarter land
25: shoulder land
30: center axial direction groove
31: bending point
32: opening end
34: center sipe
35: center narrow groove
40: quarter axial direction groove
41: bending point
42: opening end
46: quarter sipe
47: quarter narrow groove
50: shoulder axial direction groove
52: bending point

What is claimed is:

1. A pneumatic tire comprising:
a main groove extending in a tire circumferential direction on a tread; and
a plurality of protrusions protruding from a bottom of the main groove and connected to walls on both sides in a tire axial direction of the main groove,
wherein each of the protrusions is provided with a narrow groove extending in an extending direction of the main groove and dividing the protrusion into both sides in the tire axial direction, and
a bottom of the narrow groove is at a higher position than the bottom of the main groove.

2. The pneumatic tire according to claim 1,
wherein a depth of the narrow groove in the protrusion is 50% or more and 80% or less of a height of the protrusion from the bottom of the main groove.

3. The pneumatic tire according to claim 1,
wherein a length in a tire circumferential direction of the protrusion is 0.8 times or more and 2.0 times or less of a width of the main groove.

4. The pneumatic tire according to claim 1,
wherein axial direction grooves or sipes opening to the main groove are provided at least on one side in the tire axial direction of the main groove, and
the protrusions are provided adjacent to opening ends of the axial direction grooves or the sipes with respect to the main groove.

5. The pneumatic tire according to claim 4,
wherein the axial direction grooves or the sipes respectively opening to the main groove are provided on both sides in the tire axial direction of the main groove, and
the protrusions adjacent to the opening ends on one side in the tire axial direction of the main groove differ from the protrusions adjacent to the opening ends on the other side in the tire axial direction of the main groove.

6. The pneumatic tire according to claim 4,
wherein bottoms of the axial direction grooves or the sipes are at a higher position than the protrusions.

7. The pneumatic tire according to claim 4,
wherein the protrusions are arranged on sides of the entire opening ends.

8. The pneumatic tire according to claim 1,
wherein the height of the protrusion is 10% or more and 30% or less of a depth of the main groove.

9. The pneumatic tire according to claim 1,
wherein, when the length in the tire circumferential direction of the protrusion is L1, and an interval between the protrusions is L2, L2:L1 is 1.0:1.0 to 1.0:2.5.

10. The pneumatic tire according to claim 1,
wherein two center main grooves close to a tire equator and two shoulder main grooves close to tire ground contact ends are provided on the tread, and
the protrusions are provided only in the two center main grooves.
